(19) United States
(12) Patent Application Publication
(10) Pub. No.: US 2026/0366546 A1
(43) Pub. Date: Nov. 19, 2026

(54) BIMINI COVER CLIP ASSEMBLY

(71) Applicant: Roswell U.S. LLC., Rockledge, FL (US)

(72) Inventor: Darrick J. Wilson, Edmonton (CA)

(21) Appl. No.: 19/209,264

(22) Filed: May 15, 2025

(51) Int. Cl. F16B 2/22; B63B 17/02

(52) U.S. Cl. CPC F16B 2/22; B63B 17/02

(57) ABSTRACT

An apparatus (100), includes a clip assembly (100) configured to secure a bimini cover (200) to a crossbar (300). The clip assembly includes: a clip body (102) having a bimini portion (102B) configured to be secured to the bimini cover, a clip portion (102C) configured to be secured to the crossbar; and a locator recess (102R); and a mechanical locator (106) configured to be secured to the crossbar and to fit into the locator recess via a clearance fit and having a locator bottom (106B).

The clip portion and the bottom of the mechanical locator collectively define a concave interface (140) configured to abut the crossbar. The locator recess is recessed from the concave interface. A geometric interference between the mechanical locator and the locator recess holds the clip body in a respective axial location (120) along a long axis (122) of the crossbar.

### FIELD OF THE INVENTION

The invention relates to a clip assembly configured to secure a bimini cover to a crossbar.

### BACKGROUND OF THE INVENTION

Bimini clips are a known way to secure a bimini cover to a crossbar. Conventional bimini clips include plastic clips that clamp around the crossbar via a natural resilience of the clip. However, fatigue stress due to repeated application and removal of the clips often limits the life of the clip and can result in the clip eventually breaking. Hence, there is room in the art for improvement.

### BRIEF DESCRIPTION OF DRAWINGS

FIG. 1A to FIG. 1D are various views of an example embodiment of a bimini cover clip assembly installed on an example embodiment of a crossbar.

FIG. 2A and FIG. 2B show an example embodiment of a clip body and a mechanical locator of the bimini cover clip assembly of FIG. 1A.

FIG. 3A and FIG. 3B are sectional views of the clip body and the mechanical locator of FIG. 2A in relation to the crossbar.

FIG. 4A to FIG. 4C are various views of an example embodiment of a bimini plate of the bimini cover clip assembly in relation to the clip body.

FIG. 5A to FIG. 5C are various views of the mechanical locator of FIG. 3A in relation to the crossbar.

### DETAILED DESCRIPTION OF THE INVENTION

Various embodiments may be understood more readily by reference to the following detailed description. Unless defined otherwise, all technical and scientific terms used herein have the same meaning as commonly understood by one of ordinary skill in the art to which this disclosure belongs.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements at the time of this writing. Furthermore, unless otherwise clear from the context, a numerical value presented herein has an implied precision given by the least significant digit. Thus, a value 1.1 implies a value from 1.05 to 1.15. The term “about” is used to indicate a broader range centered on the given value, and unless otherwise clear from the context implies a broader range around the least significant digit, such as “about 1.1” implies a range from 1.0 to 1.2. If the least significant digit is unclear, then the term “about” implies a factor of two, e.g., “about X” implies a value in the range from 0.5X to 2X, for example, about 100 implies a value in a range from 50 to 200. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

The present inventor has devised a unique and innovative bimini cover clip assembly that secures a bimini cover to a crossbar. The clip assembly is configured to be secured to the crossbar without flexing, which increases the lifespan of the clip assembly. The clip assembly is also configured to adjustably position the bimini cover. This accommodates changes in the bimini cover such as shrinkage over time. In addition, the clip assembly incorporates features that make it easier for a customer to install.

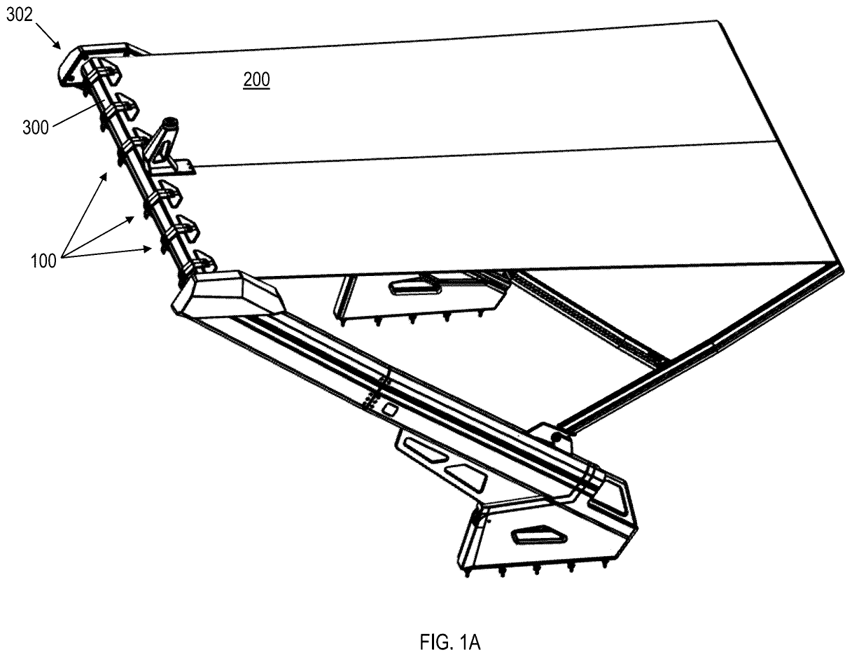

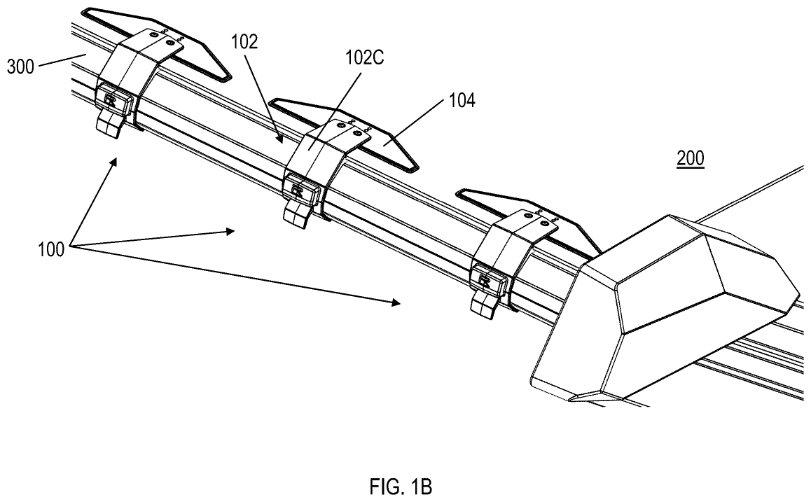

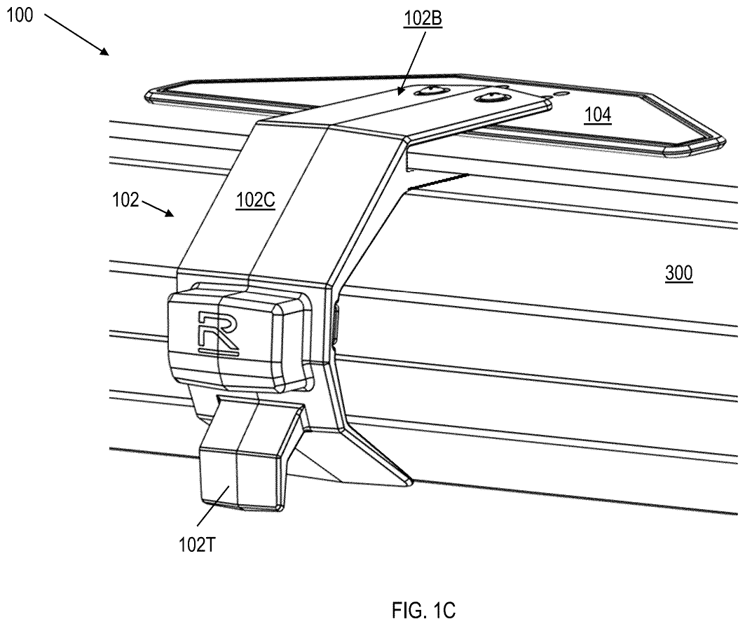

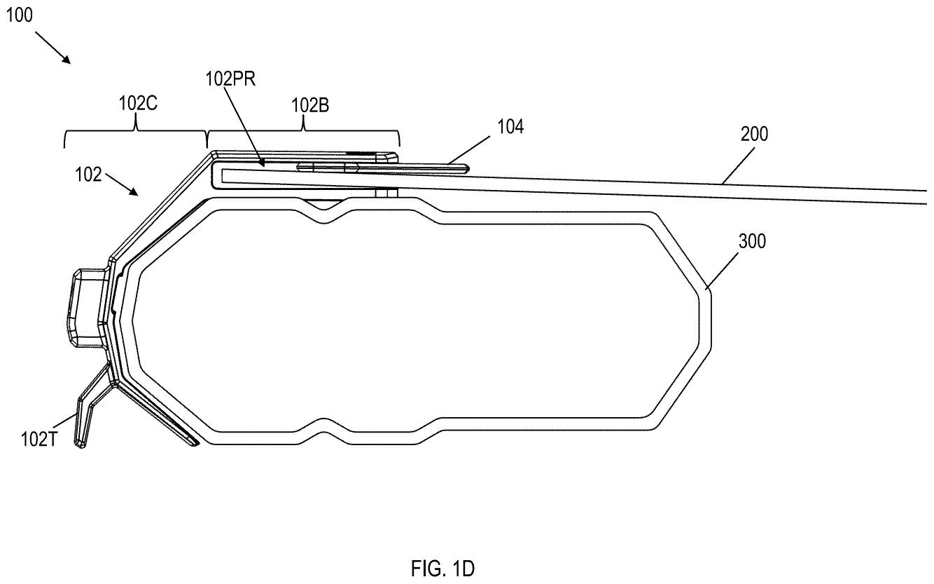

FIG. 1A to FIG. 1D are various views of an example embodiment of a bimini cover clip assembly 100 being used to secure a bimini cover 200 to an example embodiment of a crossbar 300 of an arch 302 that may be found on marine vessels.

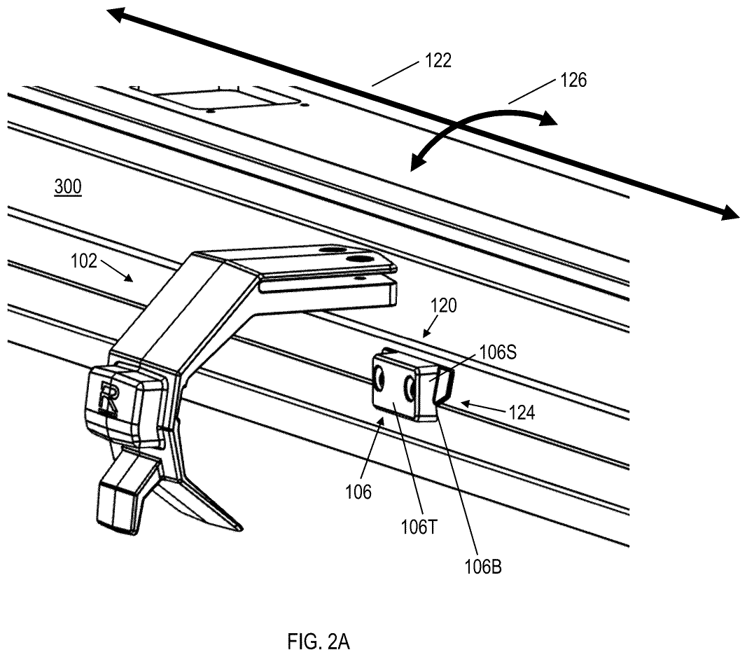

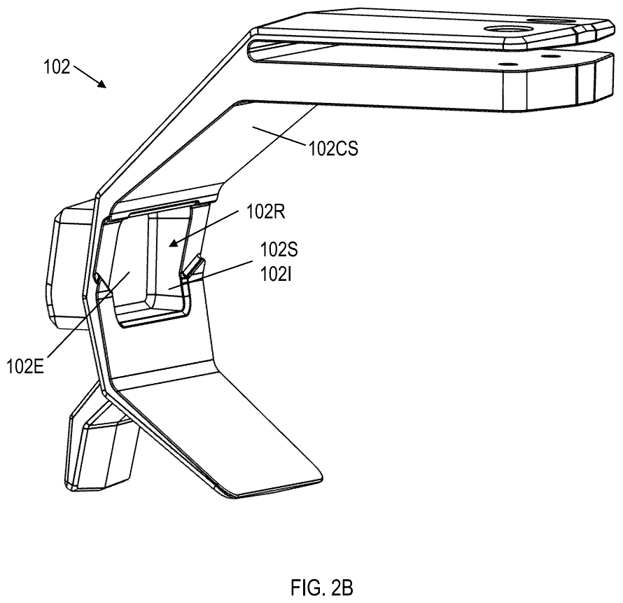

The clip assembly 100 includes clip body 102, a bimini plate 104, and a mechanical locator 106 (see FIG. 2A). The clip body 102 includes a bimini portion 102B configured to be secured to the bimini plate 104, a clip portion 102C configured to be secured to the crossbar 300, a locator recess 102R (see FIG. 2B) configured to receive therein the mechanical locator 106, and a pulling tab 102T configured to enable a user to handle the clip assembly 100, including seating the locator recess 102R on the mechanical locator 106 and unseating the locator recess 102R from the mechanical locator 106.

In an example embodiment, the locator recess 102R is configured to receive the mechanical locator 106 therein via a clearance fit. As used herein, a clearance fit means the mechanical locator 106 will always fit into the locator recess 102R without requiring tools or manual force (positive clearance). Some play between the locator recess 102R and the mechanical locator 106 is possible, but it is not necessary. As used herein, a clearance fit and a slip fit are synonymous with each other. In other example embodiments, other fits may be used. For example, a manual press may be required to properly seat the clip body 102 onto the mechanical locator 106. Further, an indication of a positive engagement may be used, such as a detectable click when the clip body 102 reaches a positive/full seated position.

The bimini portion 102B includes a bimini plate recess 102PR configured to adjustably position (sandwich) therein the bimini plate 104. The ability to adjustable position the bimini plate 104 enables adjustment of tension in the bimini cover 200 as conditions change, such as shrinkage of the bimini cover 200 over time.

FIG. 2A and FIG. 2B show the clip body 102, its locator recess 102R, and the mechanical locator 106. The locator recess 102R (e.g., a blind hole) includes a recess side 102S and recess end 102E. The recess side 102S defines a recess interface 102I. When the recess side 102S is a surface (e.g. continuous as shown, or interrupted), the recess interface 102I is defined by the surface. In instances when the recess side 102S includes raised features such as ribs and/or dimples and the like, the recess interface 102I is defined by apexes of the raised features that will contact a locator interface 106I of the mechanical locator 106 when the locator recess 102R is seated on the mechanical locator 106.

The mechanical locator 106 includes a locator bottom 106B configured to be secured to the crossbar 300, a locator top 106T, and a locator side 106S that connects the locator bottom 106B to the locator top 106T. The locator side 106S defines the locator interface 106I. When the locator side 106S is a surface (e.g. continuous as shown or interrupted), the locator interface 106I is defined by the surface. In instances when the locator side 106S includes raised features such as ribs and/or dimples and the like, the locator interface 106I is defined by apexes of the raised features that will contact the recess interface 102I of the locator recess 102R when the locator recess 102R is seated on the mechanical locator 106.

In example embodiments, a shape of the recess interface 102I matches a shape of the locator interface 106I. For example, when the locator recess 102R and the locator side 106S are each composed of a respective surface, the recess interface 102I and the locator interface 106I may both be rectangular, or both may be circular, or both may be oval etc.

When the locator recess 102R and the locator side 106S are each composed of respective sides with raised features, the apexes that form the recess interface 102I and the locator interface 106I may both be rectangular, or both may be circular, or both may be oval etc. Such example embodiments may range from uniformly sized and distributed dimples/ribs raised from a surface and whose apexes form the respective interface, to less closely related shapes such as an X-shaped mechanical locator 106 that cooperates with a square shaped locator recess 102R. In the latter case, lines that connect the apexes of the X-shape form a square shaped locator interface 106I that cooperates with the square shaped recess interface 102I.

When the locator recess 102R is seated on the mechanical locator 106, a geometric interference between the mechanical locator 106 and the locator recess 102R alone is sufficient to hold the clip body 102 in a respective axial location 120 along a long axis 122 of the crossbar 300 and to hold the clip body 102 in a respective circumferential location 124 along a circumference 126 of the crossbar at the axial location 120. Contact between the locator top 102T and the recess end 102E is optional. Moreover, the recess end 102E may be closed (as shown) or open.

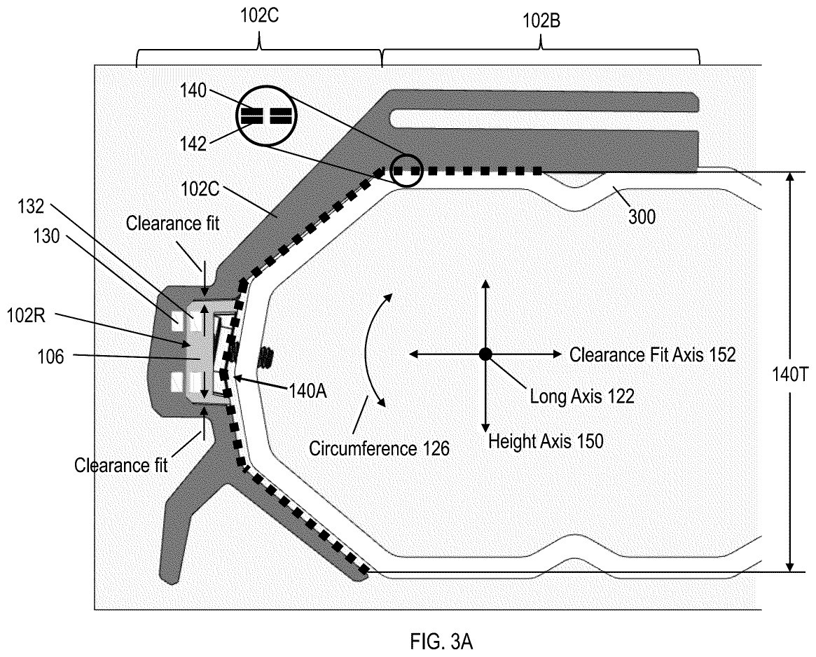

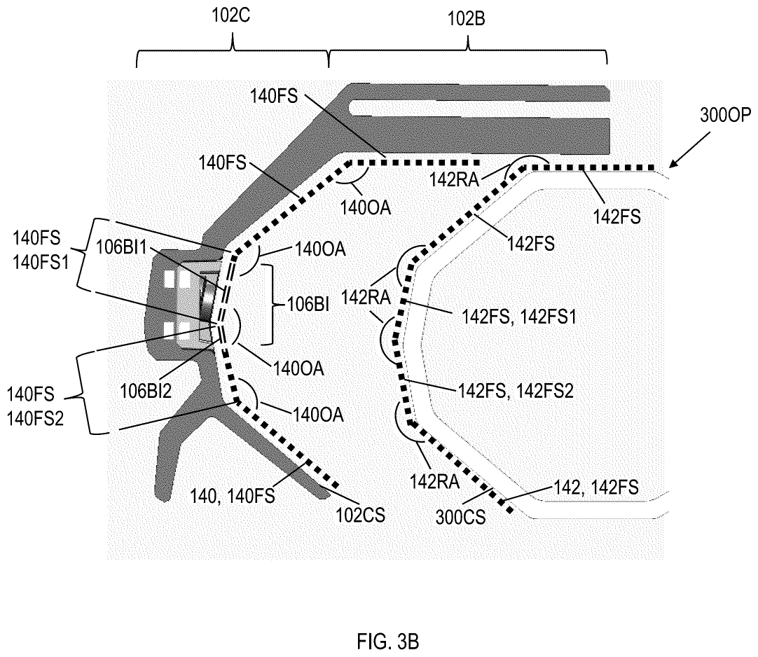

In an example embodiment, the clip body 102 includes an optional clip magnet 130 embedded therein (e.g., via overmolding). (See FIG. 3A). In the example embodiment, the mechanical locator 106 includes an optional locator magnet 132. When the locator recess 102R is seated on the mechanical locator 106 the clip magnet 130 and the locator magnet 132 are configured to create a magnetic force therebetween that is (alone) sufficient to retain the clip body 102 on the mechanical locator 106. Example magnets include rare earth magnets that are oriented to be attracted to each other when the locator recess 102R is seated on the mechanical locator 106. The clip magnet 130 and the locator magnet 132 also aid in seating the locator recess 102R on the mechanical locator 106 and creating a desired fit therebetween.

The clearance fit, the relatively rigid materials, and the magnetic force work together to create an audible sound and unmistakable clunk feel when the clip body 102 seats on the mechanical locator 106.

As can be seen in FIG. 3A and FIG. 3B, when the clip body 102 is seated on the mechanical locator 106, the clip body 102 and the mechanical locator 106 collectively define a concave interface 140 configured to abut a convex interface 142 of the crossbar 300. The interfaces are drawn as separate dotted and dashed lines slightly apart from the surfaces that define them for clarity. However, any reference to an interface is a reference to a surface that defines the interface.

The concave interface 140 may be defined by a concave surface 102CS (e.g. continuous as shown, or interrupted) of the clip portion 102C. Alternately, the concave interface 140 may be defined by apexes of raised features that will contact the convex interface 142 of the crossbar 300. Likewise, the convex interface 142 may be defined by a convex surface 300CS (e.g. continuous as shown, or interrupted) of the crossbar 300. Alternately, the convex interface 142 may be defined by apexes of raised features that will contact the concave interface 140 of the clip portion 102C.

Because the throat opening 140T (on right side as seen in FIG. 3A) of the concave interface 140 is large enough to accommodate a full height (along a height axis 150) of the convex interface 142, the clip body 102 is able to seat on the mechanical locator 106 without flexing (without increasing the dimension of the throat opening 140T along the height axis) by moving the clip body 102 along a clearance fit axis 152. In other words, the clip portion 102C does not clamp around the crossbar 300 when seated on the crossbar 300. Instead, the magnetic attraction between the clip magnet 130 and the locator magnet 132 alone is sufficient to retain the clip body 102 on the mechanical locator 106 and thereby on the crossbar. In practice, when the bimini cover is secured in place, there will be tension in the bimini cover 200 and that tension will also aid in holding the clip body 102 on the crossbar 300. Consequently, the clip body 102 can be formed of relatively rigid materials such as plastics or even metals that are optionally coated to prevent abrasion of the crossbar 300.

In an example embodiment, an outer perimeter 300OP of the crossbar 300 forms the convex interface 142 via a plurality of convex interface flat segments 142FS. Adjacent convex interface flat segments 142 form respective reflex angles 142RA, where a reflex angle is greater than 180 degrees and less than 360 degrees.

In the example embodiment, to match the convex interface 142, the concave interface 140 includes a plurality of concave interface flat segments 140FS. Adjacent concave interface flat segments 140FS form respective obtuse angles 1400A, where an obtuse angle is greater than 90 degrees and less than 180 degrees.

As can be seen best in FIG. 3A, the obtuse angles 1400A cooperate with respective reflex angles 142RA, and the concave interface flat segments 140FS cooperate with respective convex interface flat segments 142FS, to enable a form fit between the concave interface 140 of the clip portion 102C and the convex interface 142 of the crossbar 300 without the need to flex the clip portion 102C.

The shapes of the concave interface 140 and the convex interface 142 are not limited to that shown in FIG. 3A. Similarly, any discrete sections may be flat or may be curved. Further, there need not be any discrete sections. Moreover, the shape of the concave interface 140 need not exactly match the shape of the convex interface 142.

The locator recess 102R is recessed into the clip portion 102C from the concave interface 140 and in an example embodiment, is recessed from an apex 140A of the concave interface 140. The concave interface 140 is also recessed relative to the concave surface 102CS.

In this example embodiment, the concave interface 140 includes a concave interface first flat segment 140FS1 and a concave interface second flat segment 140FS2 that is adjacent the concave interface first flat segment 140FS1. The locator recess 102R is recessed into the clip portion 102C from the concave interface first flat segment 140FS1 and the concave interface second flat segment 140FS2.

The locator bottom 106B includes a locator bottom interface 106BI comprising a locator bottom interface first flat segment 106BI1 and a locator bottom interface second flat segment 106BI2. The locator bottom interface first flat segment 106BI1 is configured to be flush with the concave interface first flat segment 140FS1, and the locator bottom interface second flat segment 106BI2 is configured to be flush with the concave interface second flat segment 140FS2, which is how they collectively define the concave interface 140.

The convex interface 142 of the crossbar 300 includes a convex interface first flat segment 142FS1 and a convex interface second flat segment 142FS2 that is adjacent the convex interface first flat segment 142FS1. The concave interface first flat segment 140FS1 and the concave interface second flat segment 140FS2 are configured to rest flush on the convex interface first flat segment 142FS1 and the convex interface second flat segment 142FS2 respectively. The same flush resting arrangement may apply to all the respective flat segments such that all flat segments of concave interface 140 rest on a respective flat segment of the convex interface 142. However, this is not necessary.

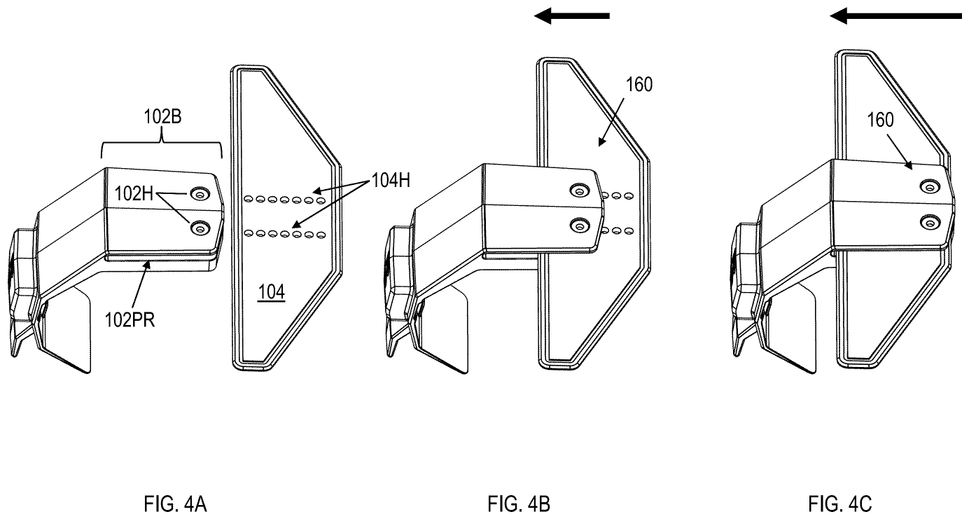

FIG. 4A to FIG. 4C show an adjustable connection 160 between the bimini portion 102B and the bimini plate 104 that allows for the bimini plate 104 to be secured to the bimini portion 102B in a variety of positions relative to the bimini portion 102B and in the bimini plate recess 102PR. This may be accomplished via series of bimini plate holes 104H that can be selectively secured using fasteners (not shown) to the bimini portion 102B at bimini portion holes 102H. Such adjustment allows for adjustment of tension in the bimini cover 200 over a wide range of conditions. The bimini portion 102B may include threaded inserts (not shown) to receive threaded fasteners. The threaded inserts may be heat melted into the bimini portion 102B.

In an example embodiment, the bimini plate 104 is sewn into the bimini cover 200. It may be composed of a softer synthetic rubber like material such as a thermoplastic polyurethane. An example hardness is 95A durometer. Such a material yields a bimini plate 104 that can be sewn but is also soft and will not damage the crossbar 300 or the arch. Once sewn to the bimini cover 200, a soldering iron may be used to melt away fabric disposed in the bimini plate holes 104H.

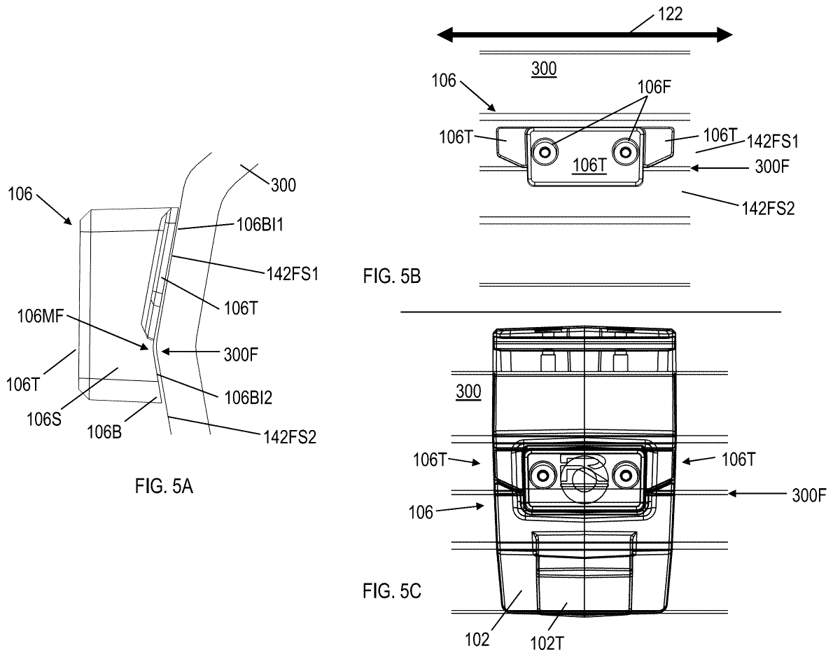

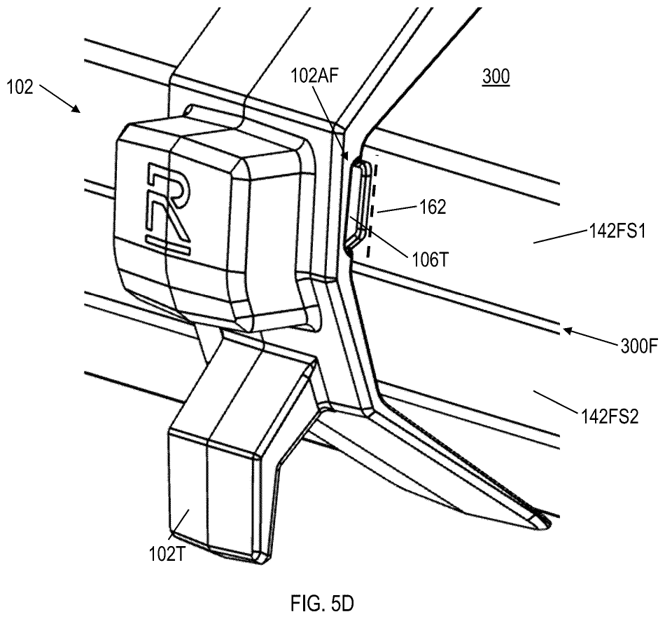

FIG. 5A to FIG. 5D show the mechanical locator 106 with respect to the crossbar 300 for installation purposes. Multiple clip assemblies 100 are used to secure the bimini cover 200 to the crossbar 300. Each clip assembly 100 is typically installed on the bimini cover 200 first. The location of a given clip assembly 100 on the bimini cover 200 determines a location of the given clip assembly 100 along the crossbar 300. Since each clip assembly 100 includes a respective mechanical locator 106, each mechanical locator 106 will then be secured to the crossbar 300 in the respective position.

Finding the correct position for the mechanical locator 106 requires assembling the mechanical locator 106 into the locator recess 102R, seating the clip body 102 with the mechanical locator 106 installed therein on the crossbar 300, and finding a position for the clip assembly 100 on the crossbar 300 that provides the best/even support for the bimini cover 200. Once this best position for the clip assembly 100 is found, the installation position for the respective mechanical locator 106 is likewise found.

However, when assembled, the clip body 102 covers the mechanical locator 106. This makes it impossible to install mechanical locator fasteners 106F that secure the mechanical locator 106 to the crossbar 300. An inaccessible mechanical locator 106 would require removing the clip body 102 and the mechanical locator 106 that is magnetically secured to the clip body 102 and making a best guess at returning the mechanical locator to the proper mounting position.

To improve the accuracy of the installation of the mechanical locator 106, the mechanical locator 106 includes alignment tabs 106TB disposed at its opposite ends (along the long axis 122). The clip body 102 includes mechanical locator access features 102AF configured to provide access to a respective alignment tab 106TB of the mechanical locator 106 when the clip body 102 is seated on the mechanical locator 106. The alignment tabs 106TB are thereby accessible even when the clip body 102 is seated on and covers the mechanical locator 106 via the mechanical locator access features 102AF. When the position for the clip body 102 on the crossbar 300 that provides the best/even support for the bimini cover 200 is found, respective reference lines 162 can be drawn against each of the alignment tabs 106TB. Once the clip body 102 and mechanical locator 106 that is magnetically secured thereto are removed, these reference lines 162 can be used to return the mechanical locator 106 to the proper mounting position along the long axis 122 and the proper position circumferentially.

In certain embodiments, the crossbar 300 has a crossbar feature 300F such as a ridge that runs parallel to the long axis 122 and is formed where the convex interface first flat segment 142FS1 and the convex interface second flat segment 142FS2 connect to each other. This crossbar feature 300F can be used as a circumferential mounting reference by incorporating a mechanical locator mounting feature 106MF such as a valley that cooperates with the crossbar feature 300F to position the mechanical locator 106 at the correct circumferential position.

The cooperation between the mechanical locator mounting feature 106MF and the crossbar feature 300F ensures the mechanical locator 106 is at the proper circumferential mounting position. The installer then only needs to ensure the mechanical locator 106 is positioned between the reference lines 162 to ensure the mechanical locator 106 is returned to the proper axial position along the long axis 122. This set of features greatly improves the ease and accuracy of installation of the mechanical locator 106.

As has been disclosed above, the present inventor has devised an apparatus with features that are improvements in the art. All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

1. An apparatus, comprising:
a clip assembly configured to secure a bimini cover to a crossbar, the clip assembly comprising:
a clip body comprising a bimini portion configured to be secured to the bimini cover, a clip portion configured to be secured to the crossbar; and a locator recess;
a mechanical locator configured to be secured to the crossbar and to fit into the locator recess via a clearance fit and comprising a locator bottom;
wherein when the clip body is seated on the mechanical locator the clip portion and the bottom of the mechanical locator collectively define a concave interface configured to abut the crossbar;
wherein the locator recess is recessed from the concave interface;
wherein when the mechanical locator is secured to the crossbar a geometric interference between the mechanical locator and the locator recess holds the clip body in a respective axial location along a long axis of the crossbar; and

2. The apparatus of claim 1,
wherein the clip body is configured to be seated on the mechanical locator without flexing.

3. The apparatus of claim 1,
wherein the geometric interference also holds the clip body in a respective circumferential location along a circumference of the crossbar at the axial location.

4. The apparatus of claim 1,
wherein the mechanical locator comprises a locator top and a locator side that connects the locator bottom to the locator top, wherein the locator side defines a locator interface;
wherein the locator recess comprises a recess side that recedes from the concave interface and that defines a recess interface; and
wherein the locator interface fits into the recess interface via the clearance fit.

5. The apparatus of claim 4,
wherein a shape of the locator interface matches a shape of the recess interface.

6. The apparatus of claim 1,
wherein the concave interface defines an apex; and
wherein the locator recess is recessed into the clip portion from the concave interface at the apex.

7. The apparatus of claim 1,
wherein the clip body comprises a clip magnet;
wherein the mechanical locator comprises a locator magnet;
wherein when the locator recess is seated on the mechanical locator the clip magnet and the locator magnet are configured to create a magnetic force therebetween that retains the clip body on the mechanical locator.

8. The apparatus of claim 1,
wherein the clip body further comprises a pulling tab disposed opposite the concave interface and opposite the bimini portion and configured to unseat the clip body from the mechanical locator when pulled upon.

9. The apparatus of claim 1,
further comprising a bimini plate that is configured to be secured to the bimini cover and to be secured to the bimini portion.

10. The apparatus of claim 9,
further comprising an adjustable connection between the bimini portion and the bimini plate that is configured to adjust position of the bimini plate relative to the bimini portion and thereby adjust a tension of the bimini cover secured to the bimini plate.

11. The apparatus of claim 10,
wherein the bimini plate comprises a bimini plate recess configured to sandwich the bimini plate therein; and
wherein the adjustable connection is configured to adjust a position of the bimini plate in the bimini plate recess and thereby adjust the tension of the bimini cover.

12. The apparatus of claim 1,
wherein the concave interface comprises a concave interface first flat segment and a concave interface second flat segment that is adjacent the concave interface first flat segment;
wherein the locator recess is recessed into the clip portion from the concave interface first flat segment and the concave interface second flat segment.

13. The apparatus of claim 12,
wherein the locator bottom comprises a locator bottom interface comprising a locator bottom interface first flat segment and a locator bottom interface second flat segment;
wherein the locator bottom interface first flat segment is configured to be flush with the concave interface first flat segment, and the locator bottom interface second flat segment is configured to be flush with the concave interface second flat segment.

14. The apparatus of claim 1,
wherein the mechanical locator comprises alignment tabs at opposite ends of the mechanical locator 106 along the long axis; and
wherein the clip body comprises mechanical locator access features configured to provide access to a respective alignment tab of the mechanical locator when the clip body is seated on the mechanical locator.

15. The apparatus of claim 1,
wherein the concave interface comprises a plurality of concave interface flat segments, wherein adjacent concave interface flat segments of the plurality of concave interface flat segments form respective obtuse angles.

16. The apparatus of claim 15,
further comprising the rail;
wherein an outer perimeter of the rail forms a convex interface defined by a plurality of convex interface flat segments, wherein adjacent convex interface flat segments of the plurality of convex interface flat segments form respective reflex angles; and
wherein the obtuse angles cooperate with respective reflex angles to enable a form fit between the concave interface and the convex interface of the rail.

17. The apparatus of claim 16,
wherein the clip body is configured to reach the form fit without flexing.

18. The apparatus of claim 16,
wherein the concave interface comprises a concave interface first flat segment and a concave interface second flat segment that is adjacent the concave interface first flat segment;
wherein the locator recess is recessed from the concave interface first flat segment and from the concave interface second flat segment;
wherein the locator bottom comprises a locator bottom interface comprising a locator bottom interface first flat segment and a locator bottom interface second flat segment;
wherein the locator bottom interface first flat segment is configured to be flush with the concave interface first flat segment, and the locator bottom interface second flat segment is configured to be flush with the concave interface second flat segment;
wherein the plurality of convex interface flat segments comprises a convex interface first flat segment and a convex interface second flat segment that is adjacent the convex interface first flat segment; and
wherein the concave interface first flat segment and the concave interface second flat segment are configured to rest flush on the convex interface first flat segment and the convex interface second flat segment respectively.

19. An apparatus, comprising:
a clip assembly configured to secure a bimini cover to a crossbar, the clip assembly comprising:
a clip body comprising a bimini portion configured to be secured to the bimini cover, a clip portion configured to be secured to the crossbar, a locator recess, and a clip magnet;
a mechanical locator configured to be secured to the crossbar, configured to fit into the locator recess, and comprising a locator magnet;
wherein when the locator recess is seated on the mechanical locator the clip magnet and the locator magnet are configured to create a magnetic force therebetween that is sufficient to retain the clip body on the mechanical locator; and
when the magnetic force retains the clip body on the mechanical locator and the mechanical locator is secured to the crossbar a geometric interference between the mechanical locator and the locator recess alone is sufficient to hold the clip body in a respective axial location along a long axis of the crossbar and to hold the clip body in a respective circumferential location along a circumference of the crossbar at the axial location.

20. The apparatus of claim 19,
wherein the mechanical locator comprises a locator bottom configured to be secured to the crossbar, a locator top, and a locator side that connects the locator bottom to the locator top, wherein the locator side defines a locator interface;
wherein the locator recess comprises a recess side and that defines a recess interface; and
wherein the locator interface fits into the recess interface via a clearance fit.

21. The apparatus of claim 19,
wherein when the clip body is seated on the mechanical locator the clip portion and the bottom of the mechanical locator collectively define a concave interface configured to abut the crossbar.

22. The apparatus of claim 21,
wherein the concave interface comprises a concave interface first flat segment and a concave interface second flat segment that is adjacent the concave interface first flat segment; and
wherein the locator recess is recessed into the clip portion from the concave interface first flat segment the concave interface second flat segment.
